(19) United States
(12) Patent Application Publication
(10) Pub. No.: US 2004/0191603 A1
(43) Pub. Date: Sep. 30, 2004

(54) Clad metallic bipolar plates and electricity-producing systems and fuel cells using the same

(76) Inventors: Joseph G. Kaiser, Barrington, RI (US); Robert P. Willis, Lincoln, RI (US)

Correspondence Address: EDWARDS & ANGELL, LLP, P.O. BOX 55874, BOSTON, MA, 02205, US

(21) Appl. No.: 10/397,000

(22) Filed: Mar. 25, 2003

(51) Int. Cl. H01M 8/02

(52) U.S. Cl. 429/34; 429/35; 429/38; 428/618

(57) ABSTRACT

A niobium-clad bipolar plate for use in a proton exchange membrane fuel cell is disclosed, whereby the electrically conductive, corrosion resistant niobium cladding protects a highly electrically conductive base metal in a harsh environment for the purpose of communicating electrical energy from the cathode of one membrane-electrode assembly to the anode of a second membrane-electrode assembly. Alternatively, the niobium-clad bipolar plate can include a titanium interlayer, interposed between the niobium cladding and the base metal. Also disclosed is a system for producing electricity using a niobium-clad bipolar plate in combination with numerous membrane-electrode assemblies to provide electrical energy and a proton exchange membrane fuel cell comprising a niobium clad-bipolar plate.

### FIELD OF INVENTION

The present invention relates to fuels cells and bipolar plates used therein and, more particularly, to bipolar plates that are manufactured using a Niobium-clad base metal for use in a proton exchange membrane-type fuel cell and systems and fuel cells using the same.

### BACKGROUND OF THE INVENTION

Fuel cells are alternative energy producing systems that create electricity from common fuel sources such as natural gas and, typically, have higher efficiencies and lower emissions than conventional systems. With fuel cells, electrical energy is produced through the chemical reaction of the fuel and air to produce electrical current.

There are a number of types of fuel cells, which include, among others, phosphoric acid, proton exchange membrane, molten carbonate, solid oxide, and alkaline. One of the most popular fuel cells is the solid polymer, i.e., proton exchange membrane, fuel cell. Proton exchange membrane (PEM) fuel cells are electro-mechanical devices that provide electrical power by reacting hydrogen gas (H₂) usually from natural gas or ethanol with an oxidant, e.g., air or oxygen gas (O₂). As stated above, the gases react to produce electrical current and, further, a relatively harmless water bi-product.

Conventionally, PEM fuel cells include a plurality, and, more preferably, a multiplicity, of membrane-electrode assemblies, or stacks. Each membrane-electrode assembly comprises a pair of opposing polarity electrodes that are spatially and electrically separated by a cation permeable, ion-conducting, electrolyte membrane that allows hydrogen ions to pass through it by ion exchange. Fluorinated sulfonic acid polymers and sulfonic acid cation exchange resins, for example, are commonly used in membranes.

A PEM fuel cell works by introducing fuel, e.g., hydrogen gas, at a first electrode (anode), where a catalyst encourages production of protons, i.e., hydrogen ions, and electrons in accordance with the following equation:

H₂catalyst>2H⁺+2e⁻

The electrons (2e⁻) are collected in an electric circuit that transmits the electrons to a second electrode (cathode). Electron flow from the anode to the cathode constitutes usable current, i.e., power. The protons (H⁺) travel through the electrolyte membrane to the cathode, where, contemporaneously, an oxidant, e.g., air or oxygen gas, is introduced. The oxidant and cathode catalyst react electrochemically with the hydrogen protons and the electrons to produce water and heat in accordance with the following equation:

2H⁺+½O₂+2e⁻catalyst>H₂O+heat

The process is efficient and environmentally friendly.

A single PEM fuel cell assembly, however, can only provide useful DC voltage of between about 0.5 to about 0.7 volts. Therefore, to enhance the capacity of a PEM fuel cell to provide greater, more useful power, multiple assemblies, or stacks, are connected in series using bipolar plates, or interconnects, which, necessarily, are highly conductive to enhance electrical conductivity, yet impervious to chemical attack. Succinctly, bipolar plates, or interconnects, transport electrons from the cathode of one assembly to the anode of an adjacent assembly.

Bipolar plates, or interconnects, comprise an upper conductive surface, i.e., electrical contact, which is in communication with the cathode of a first assembly and a lower conductive surface, which is in communication with the anode of a second assembly. Thus, electrons can flow, i.e., current can be conducted, between adjacent assemblies, or stacks, i.e., from the cathode of the first assembly to the anode of the second assembly, and so on. Current collectors, or end plates, having a free face, which is to say that, the assemblies include either an anode or a cathode that is not disposed opposite, respectively, a cathode or an anode of an adjacent assembly typically collect the electrical power and deliver it to a junction.

Due to their location, i.e. proximity, with respect to the electrodes, bipolar plates, or interconnects, are frequently used to channel the gases across the catalytic membrane at the electrodes and/or to transport the water bi-product for removal. Typically, bipolar plates that are used to channel gases and/or to transport water are structured and arranged to provide a plurality of lands or peaks and channels or troughs, which can produce a corrugated appearance. For example, hydrogen gas can be channeled through one or more channels that are created between adjacent lands that provide the electrical contact against the anode. Similarly, oxygen gas, or air, can be channeled through the one or more channels that are created between adjacent lands that provide the electrical contacts with the cathode.

The operating environment of a PEM fuel cell, however, is harsh. Indeed, cathodes are exposed to an oxidizing environment in which elements of the device are constantly exposed to an oxidant and moisture. Anodes, on the other hand, operate in an acidic, corrosive environment, i.e., pH levels of about 3. Accordingly, bipolar plates, or interconnects, must be corrosion resistant to acids at the one electrode and resistant to oxidation at the other electrode in addition to being electrically conductive.

Bipolar plates fabricated from metals, metal alloys, and carbonaceous materials have been practiced by those skilled in the art. For example, bipolar plates fabricated from cupper (Cu) and Nickel (Ni) and alloys containing those metals are highly conductive and can be fashioned into very thin plates, which are two desirable properties of interconnects. However, in a harsh PEM environment, bipolar plates fabricated from such metals and their alloys are susceptible to corrosion, which can lead to a steady degradation, oxidation, and/or dissolution of the metal or alloy itself. Such degradation, oxidation, and/or dissolution can adversely form corrosion products that can negatively affect the performance of the polymer membranes.

As an alternative to bipolar plates fabricated from cupper (Cu), nickel (Ni), and their alloys, bipolar plates can be fabricated from aluminum (Al), titanium (Ti), and their alloys, and/or stainless steel. Interconnects fabricated from these metals and alloys are slightly less conductive than those fabricated from cupper (Cu), nickel (Ni), and their alloys, but, advantageously, less susceptible to corrosion. However, plates fabricated from these metals can oxidize, which is to say that they can react in the harsh environment to produce an oxide film on the outer surfaces of metal. The insulating nature of these oxide films increases resistivity, which decreases conductive performance because the oxide film separates and partially insulates the metal conductor from the electrode.

Some of those skilled in the art have proposed using bipolar plates fabricated from graphite. Beneficially, graphite plates are electrically conductive—albeit significantly less conductive than the above-mentioned metals and alloys—and corrosion resistant and oxidation free. However, disadvantageously, graphite is brittle. Hence, there is a limit as to how thin the bipolar plate can be made, which is a disadvantage because thicker interconnects take up much needed volume. Furthermore, fabrication costs are high compared to metals. Indeed, whereas metals can be fabricated by stamping and/or forming, which are relatively cheap and easy processes, bipolar plates fabricated from graphite, as a rule, must be molded. Thus, graphite bipolar plates also are not ideal.

Cast and/or machined ceramic bipolar plates also have been proposed as a non-metallic alternative. Ceramic bipolar plates are electrically conductive, but, here again, significantly less so than metallic or alloyed bipolar plates, corrosion resistant, and stable. However, much like graphite, ceramic bipolar plates are brittle and are limited in how thin they can be fabricated.

Others have proposed coating a stainless steel base metal substrate with aluminum (Al) and, further, diffusing the aluminum (Al) into the stainless steel at high temperature to provide corrosion protection. Stainless steel and aluminum (Al) individually and jointly exhibit greater electrical conductivity than either graphite or ceramic. However, aluminum (Al) can oxidize as describe above. Furthermore, cracks, which can extend through the corrosion protection layer into the stainless steel, can form during the diffusion process, which can provide a means for water and acids to attack the base metal. Recognizing this, U.S. Pat. No. 5,399,438 to Tateishi, et al. teaches fabricating PEM end plates using a stainless steel base metal and precipitating a granular heterophase containing chromium (Cr) in an ordered alloy made of aluminum (Al) and constituent elements of the base metal. However, the fabrication process of Tateishi, et al. can be expensive. Moreover, there remains the possibility of an imperfection through which the corrosive environment could attack the stainless steel.

U.S. Pat. No. 6,372,376 to Fronk, et al. teaches applying a protective coating comprising electrically-conductive, corrosion-proof filler particles, e.g., gold (Au), platinum (Pt), carbon (C), graphite (G), nickel (Ni), titanium (Ti) alloyed with chromium (Cr) and/or nickel (Ni), titanium nitride, titanium carbide, titanium diboride, palladium (Pd), niobium (Nb), rhodium (Rh), rare earth metals, and other noble metals, that are dispersed throughout an acid-resistant, water-insoluble, oxidant-resistant polymer matrix, e.g., polyphenols, polyesters, silicone, epoxies, and the like, to a base metal, e.g., aluminum (Al), titanium (Ti) and stainless steel. However, the method of manufacturing the PEM fuel cells involves several steps of brushing, spraying, laminating, and/or electrophoretically depositing successive layers of the polymer matrix and the filler to the base metal.

U.S. Pat. No. 6,203,936 to Cisar, et al. discloses a lightweight bipolar plate comprising an electrically-conductive base metal substrate, e.g., magnesium (Mg), aluminum (Al), and their alloys, that is plated, coated, and/or annealed with at least one corrosion-resistant metal layers, e.g., platinum (Pt), gold (Au), iridium (Ir), palladium (Pd), ruthenium (Ru), nickel (Ni), and cobalt (Co) and mixtures thereof, using an aqueous or a non-aqueous solution. In an aqueous application, typically, the method of manufacture includes the steps of pre-treating the surface of the base metal to remove oxides and other contaminants from the surface of the substrate; immersing the substrate in a Ni displacement bath for Ni deposition in an aqueous, oxygen-free environment; immersing the substrate in an electroless Ni displacement bath for deposition, and electroplating with, e.g., a precious metal. Nickel, however, is toxic and, moreover, plating technology typically cannot avoid producing micro-porosity, wherein microscopic channels in the plating can be produced during the plating process. Further, plated substrates have rarely been successful due to breakthrough by mechanical failure, e.g., mechanical cracking of the outermost layer that extends to or into the base metal substrate, and/or micro-porosity, which can produce corrosion failures. Moreover, plating usually is most effective if plating thicknesses are taken to an extreme to guard against breakthrough via mechanical failure, e.g., by cracking of the outermost layer, and/or micro-porosity. Thus, plating can be prohibitively expensive if the thickness is excessive.

Thus, it would be desirable to provide a bipolar plate for use, inter alia, in a PEM fuel cell that is lightweight and thin, corrosion resistant, electrically-conductive, and simple to manufacture.

### SUMMARY OF THE INVENTION

It is highly desirable that bipolar plates, or interconnects, are corrosion resistant and chemically inert to provide protection in the harsh PEM fuel cell environment. Preferably, bipolar plates should maintain good electrical conductivity in bulk and maintain a low electrical surface contact resistance after extended use, operation, and exposure to the harsh PEM fuel cell environment. Bipolar plates, or interconnects, further, should enhance thermal conductivity to remove and/or manage heat. Implicitly, the reaction of the bi-polar plate to the harsh environment should not produce or release ions that can be harmful or deleterious to the performance of the membrane.

It is also desirable that bipolar plates are structured and arranged to channel the fuel, e.g., hydrogen, and oxidant, e.g., oxygen, gases across the catalytic membrane. Thus, interconnects preferably should be virtually impervious to provide an airtight seal to prevent release of hydrogen and/or oxygen gas from the assembly. Because water is a bi-product of the chemical process it is desirable that, the surface of the interconnects should enhance the transport of water.

Preferably, the bipolar plates, or interconnects, are pliable and made as thin as possible to enhance higher density output cells. Moreover, bi-polar plates, or interconnects, should be economical and simple to manufacture.

In one embodiment, the present invention provides an electrically-conductive, corrosion-resistant device for communicating electrical energy in an electrochemical apparatus, the device comprising a composite metal sheet, the composite metal sheet further comprising:

a base metal substrate, having an upper and a lower surface, wherein the base metal has a first electrical conductivity;

at least one top layer of a conductive, corrosion-resistant material that is metallurgically clad to the upper surface of the base metal substrate; and

at least one bottom layer of a conductive, corrosion-resistant material that is metallurgically clad to the lower surface of the base metal substrate,

wherein the at least one bottom layer and the at least one top layer have a second electrical conductivity that is less than the first electrical conductivity.

Furthermore, in a second embodiment, the present invention provides a system for producing electricity, wherein the system comprises:

a plurality of membrane-electrode assemblies, wherein each of the plurality of membrane-electrode assemblies comprises:

a negatively charged electrode against which hydrogen gas is introduced with a first catalyst to provide electricity and a plurality of hydrogen ions,

a positively charged electrode against which an oxidant is introduced with a second catalyst in the presence of the plurality of hydrogen ions to provide water, and

a membrane that is interposed between the negatively charged electrode and the positively charged electrode for the transport of the plurality of hydrogen ions from said negatively charges electrode to said positively charged electrode;

a device for communicating electricity between an electrode of a first membrane-electrode assembly and an electrode of opposite charge of a second membrane-electrode assembly, wherein the device comprises a composite metal sheet further comprising:

a base metal substrate, having an upper and a lower surface, wherein the base metal has a first electrical conductivity, at least one top layer of an electrically-conductive, corrosion-resistant material that is metallurgically clad to the upper surface of the base metal substrate, and

at least one bottom layer of an electrically-conductive, corrosion-resistant material that is metallurgically clad to the lower surface of the base metal substrate, wherein the at least one bottom layer and the at least one top layer have a second electrical conductivity that is less than the first electrical conductivity;

a first current collector plate, wherein the first current collector is in electrical communication with a positively charged electrode of one of the plurality of membrane-electrode assemblies, which electrode is not in communication with the device for communicating electricity between an electrode of a first membrane-electrode assembly and an electrode of opposite charge of a second membrane-electrode assembly; and

a second current collector, wherein the second current collector is in electrical communication with a negatively charged electrode of another of the plurality of membrane-electrode assemblies, which electrode is not in communication with the device for communicating electricity between an electrode of a first membrane-electrode assembly and an electrode of opposite charge of a second membrane-electrode assembly.

In a third embodiment, the present invention provides a proton exchange membrane fuel cell, the fuel cell comprising:

an inlet for providing fuel to a first electrode;

an inlet for providing an oxidant gas to a second electrode;

a plurality of membrane-electrode assemblies, wherein each of the plurality of membrane-electrode assemblies comprises:

a negatively charged electrode against which hydrogen gas is introduced with a first catalyst to provide electricity and a plurality of hydrogen ions,

a positively charged electrode against which an oxidant is introduced with a second catalyst in the presence of the plurality of hydrogen ions to provide water, and

a membrane that is interposed between the negatively charged electrode and the positively charged electrode for the transport of the plurality of hydrogen ions from said negatively charges electrode to said positively charged electrode;

a device for communicating electricity between an electrode of a first membrane-electrode assembly and an electrode of opposite charge of a second membrane-electrode assembly, wherein the device comprises a composite metal sheet further comprising an electrically conductivity base metal substrate having at least one top layer of an electrically-conductive, corrosion-resistant material metallurgically clad to an upper surface of the base metal substrate and at least one bottom layer of an electrically-conductive, corrosion-resistant material metallurgically clad to a lower surface of the base metal substrate, wherein the at least one top layer of a corrosion-resistant material clad to the upper surface of the base metal substrate is in electrical communication with the electrode of the first membrane-electrode assembly and the at least one bottom layer of a corrosion-resistant material clad to the lower surface of the base metal substrate is in electrical communication with the electrode of the second membrane-electrode assembly;

one or more first current collectors, wherein each of the one or more first current collectors is in electrical communication with a positively charged electrode of one of the plurality of membrane-electrode assemblies, which electrode is not in communication with the device for communicating electricity between an electrode of a first membrane-electrode assembly and an electrode of opposite charge of a second membrane-electrode assembly;

one or more second current collectors, wherein each of one or more second current collectors is electrical communication with a negatively charged electrode of another of the plurality of membrane-electrode assemblies, which electrode is not in communication with the device for communicating electricity between an electrode of a first membrane-electrode assembly and an electrode of opposite charge of a second membrane-electrode assembly; and

electrical circuitry for communicating electricity produced by the proton exchange membrane fuel cell to an external load.

### BRIEF DESCRIPTION OF THE DRAWINGS

For a fuller understanding of the present invention, reference is made to the following detailed description taken in conjunction with the accompanying figures wherein like reference characters denote corresponding parts throughout the several views and wherein:

FIG. 1 shows a cross-sectional view of an embodiment of a bipolar plate in accordance with the present invention;

FIG. 2A shows a diagrammatic plan view of an embodiment of a bipolar plate in accordance with the present invention;

FIG. 2B shows a cross-section elevation view of an embodiment of a bipolar plate in accordance with the present invention taken from FIG. 2A; and

FIG. 3 shows a schematic, exploded view of an embodiment of a proton exchange membrane fuel cell having two membrane-electrode assemblies in accordance with the present invention.

### DETAILED DESCRIPTION OF THE INVENTION INCLUDING THE PREFERRED EMBODIMENTS THEREOF

The preferred characteristics of a bipolar plate include very high electrical conductivity, very stable corrosion performance as it relates to surface contact resistance and the evolution of deleterious ions, very low permeability, durability, and malleability. The conductivity, resistivity, and permeability characteristics enable the interconnect to survive the harsh environment of a PEM fuel cell. Durability and malleability enable the interconnect to be manufactured as thin as possible so as to take up as little space in the fuel cell as possible to increase the density of current producing membrane-electrode assemblies in the design space of the fuel cell.

Materials suitable for use in bipolar plate manufacture will now be discussed. The prior art has shown that metallic and non-metallic bipolar plates are in common use. By comparison, metallic bipolar plates, as a rule, have a significantly higher electrical conductivity; have a lower permeability; are more durable; and are more malleable than non-metallic, e.g., graphite or carbonaceous materials, bipolar plates. Non-metallic interconnects, typically, are more resistant to chemical corrosion than metallic interconnects. Cost per cubic inch of a non-metallic bi-polar plate may be lower. However, non-metallic bipolar plates are not necessarily the cheaper alternative because metallic interconnects can be made thinner than interconnects made from graphite or carbonaceous materials, which promotes higher density of membrane-electrode assemblies. Additionally, fabrication techniques for metals, e.g., stamping and forming, are considerably less expensive than fabrication techniques for non-metals, e.g., machining and molding. As a result, a metallic bipolar plate is preferable to known non-metallic bipolar plates.

The molecular geometry of metals, like that of all elements, can be described as a nucleus comprising protons and neutrons surrounded by one or more levels, or shells, of orbiting electrons, wherein each shell is exemplified by a radial distance from the nucleus of the element or metal. Indeed, the periodic table of Mendelaev grouped elements in columns as a function of the number of electrons in the outermost shell and in rows as a function of the number of electrons shells. For example, copper (Cu), silver (Ag), and gold (Au) are located in the same column as each has a single electron in its outermost shell. Iron (Fe), nickel (Ni), and copper (Cu) are located in the same row as each has four orbital shells.

Elements and metals that have a single electron in their outermost energy level, or electron shell, as a rule, are better conductors than elements and metals that have more than a single electron in their outermost shell. This stands to reason, as shells that are full or contain more electrons, generally, are more resistant to movement of more electrons than those shells that are less full. For example, cupper (Cu), silver (Ag), and gold (Au) each include a single electron in their outermost electron shell and each is a good conductor. At 20 degrees Centigrade (° C.), the electrical resistivity of copper (Cu), silver (Ag), and gold (Au) is about 1.7 μΩ-cm, 1.6 μΩ-cm, and 2.1 μΩ-cm, respectively.

Copper (Cu) and silver (Ag) are better pure electrical conductors than gold (Au) and both are cheaper in bulk. However, copper (Cu) can oxidize and/or corrode at an unacceptable rate in the harsh PEM fuel cell environment. Dissolved ions of the more corrosion-resistant silver (Ag) are known to be deleterious to membrane performance. Alternatively, gold (Au), which is slightly less conductive, is more chemically resistant than either silver (Ag) or copper (Cu), which, but for the cost, would make gold (Au) a better choice for a bipolar plate.

Further study and comparison of the elements and their properties provide other metals that are suitable conductors of electricity. Listed in order of decreasing conductivity, or, alternatively, in order of increasing resistivity, they include aluminum (Al), rhodium (Rh), iridium (Ir), tungsten (W), molybdenum (Mo), zinc (Zn), nickel (Ni), ruthenium (Ru), palladium (Pd), platinum (Pt), chromium (Cr), niobium (Nb), and titanium (Ti). Many of these metals are among the noble metals and/or the refractory group.

However, in highly acidic or oxygen rich environments, which are characteristic of a PEM fuel cell, many of these metals, such as aluminum (Al) and iron (Fe) can oxidize and corrode. Others, e.g., titanium (Ti) and stainless steel, and alloyed mixture of metals, form passivating oxide films on their surfaces. As stated before, these oxide films are electrically resistant and therefore detrimental to micro- and macro-level performance of the fuel cell.

Through experimentation, in a preferred embodiment, the present invention provides bipolar plates that are fabricated from thin sheets of a base metal substrate, e.g., stainless steel, aluminum (Al), aluminum (Al) alloys, titanium (Ti), titanium (Ti) alloys, and copper-iron (Cu/Fe) alloys, onto the opposing outer surfaces of which very thin layers, e.g., about 0.1 to about 3 mils thick, of niobium (Nb) can be metallurgically clad for electrical contact and corrosion resistance. The preferred properties of the base metal are a high electrical conductivity, typically higher than the niobium (Nb) cladding, malleability, and durability. Stable corrosion performance and permeability are of lesser importance but remain desirable properties.

Cladding technology, which is well known to the art, can significantly improve the performance of the bipolar plate. Conventional plating and deposition technologies often provide porous coatings that can allow the harsh PEM environment to attack the base metal substrate. Conventional plating and deposition technologies, further, can delaminate during application and/or during the operational life of the interconnect. Cladding, on the other hand, provides a virtually pore-free coating to the outer surfaces of the base material substrate. Moreover, cladding provides a metallurgical bond between the base metal and the cladding material, i.e., niobium (Nb), which eliminates delaminating. Cladding also preserves the ductility and strength of the individual clad components.

Niobium (Nb) in the past has been used selectively in industrial application by those skilled in the art. For example, niobium (Nb) is used in crucibles that are used in the manufacture of synthetic diamond. However, because of its cost, those skilled in the art have not used niobium (Nb) widely as an electrical contact material. Hence, such use in this application is believed to be novel.

Niobium (Nb) is a suitable cladding material because it is ductile, formable, and malleable, which permits very thin, i.e., about 0.1 to about 3 mils thick, corrosion protective layers on opposing outer surfaces of a base metal. Moreover, niobium (Nb) is virtually porous free and the texture of the niobium (Nb) surface can be modified easily during the forming and final rolling stages of manufacture. By modifying the texture of the niobium (Nb) surface, one can enhance the transport mechanism for the water bi-product within the plate channels. Niobium (Nb) also is virtually impermeable so the moist hydrogen and oxygen gases that can be channeled within the plate channels are not likely to escape and the aforementioned water bi-product is not likely to permeate the niobium (Nb) cladding to attack the more-corrosive base metal. For this embodiment, the composite sheet for a bipolar plate that comprises the base metal substrate and the niobium (Nb) cladding can be about 2 mils to about 0.1 inches thick.

As an electrical conductor, niobium (Nb) is also suitable because it exhibits low electrical contact resistance. Thin oxides can form on the surface of the niobium (Nb) layer due to the harsh PEM environment. However, the oxide film exhibits acceptable conductivity to warrant use of niobium (Nb).

Although the best mode of practicing the present invention includes use of niobium (Nb) as an outer cladding material in combination with base metals that provide good formability, good bulk electrical and/or thermal conductivity, and good corrosion resistance at the lowest cost, the invention is not to be construed as being so limited. Indeed, those skilled in the art can appreciate that use of tantalum, titanium, ruthenium, rhodium, palladium, silver, iridium, platinum, gold, tungsten, tellurium, refractory group metals, and alloys thereof as an outer cladding material is feasible and within the scope and spirit of this disclosure.

In an alternative embodiment, use of a less corrosive resistant metal than stainless steel, aluminum (Al), aluminum alloys, titanium (Ti), titanium alloys, and copper (Cu) alloys as a base metal, can be possible, if an interlayer, or barrier layer, e.g., of titanium (Ti), stainless steel, and the like, is formed between the outer niobium (Nb) cladding and the base metal. The interlayer can provide another virtually impervious, corrosion resistant, electrically conductive layer beneath the, e.g., niobium (Nb), outer layer to guard against imperfections, e.g., pores or tooling marks in the outer layer. In comparison with the outer, niobium clad, the interlayer can be at least one of more electrically conductive, less impervious, and less corrosion resistant. In comparison with the base metal, the interlayer can be at least one of less electrically conductive, more impervious, and more corrosion resistant.

Indeed, according to this alternative embodiment of the present invention, bipolar plates can be fabricated from thin sheets of a base metal substrate, onto to the opposing outer surfaces of which very thin layers of niobium (Nb) and titanium (Ti), e.g., 0.1 to three (3) mils and one (1) to five (5) mils, respectively, can be metallurgically clad of the base metal for electrical contact. The composite sheet for a bipolar plate that comprises the base metal substrate and the niobium (Nb) cladding with titanium (Ti) interlayers can be about two (2) mils to about 0.1 inches thick.

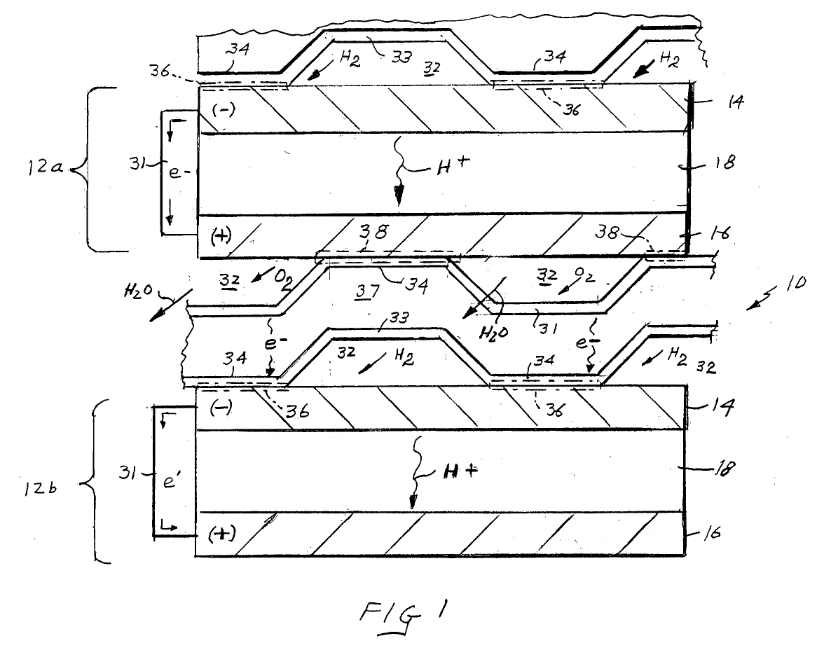

Preferably, after cladding, which techniques are well-known to the art, the niobium-clad base metal substrate is manufactured, e.g., drawn, formed or forged, to include a corrugated geometry to provide a plurality of lands for use as electrical contacts and a plurality of plate channels through which fuel, oxidants, and the water bi-product can travel. FIG. 1 shows a cross-sectional view of an illustrative embodiment of the corrugated geometry of a bipolar plate 10. Although the corrugated geometry of the present invention is shown illustratively as substantially trapezoidal waves, the invention is not to be construed as being so limited. Indeed, the configuration of the corrugations, for example, can be sinusoidal, triangular, rounded, or rectangular without violating the scope and spirit of this disclosure. Those skilled in the art can configure the bipolar plate 10 in a myriad of shapes that will adequately serve the function for which bipolar plates 10 are designed.

FIG. 1 illustrates a system for producing electrical power comprising a pair of membrane-electrode assemblies 12a and 12b with a bipolar plate 10 interposed therebetween. Each of the membrane-electrode assemblies 12a and 12b comprises a first electrode, which, typically, is a negatively charged anode 14, and a second electrode, which, typically, is a positively charged cathode 16. A membrane 18, e.g., a fluorinated sulfonic acid membrane, is interposed between the anode 14 and cathode 16 of each membrane-electrode assembly 12a and 12b. Membrane-electrode assemblies 12a and 12b are well-known to the art and will not be discussed in detail herein. Succinctly, fuel, e.g., hydrogen gas H₂, ethanol, natural gas, and the like, is introduced, i.e., passed over, a catalytic material, e.g., platinum (Pt), at the anode 14. Preferably, the fuel is introduced through a plurality of plate channels 32, which corresponds to the trough portions of the bipolar plate 10. The lands 34, or peaks, on opposite sides of the bipolar plates 10 communicate and provide an electrical contact with the anode 14 at a first contact surface 36. The nature of the communication/electrical contact surfaces 36 can include welding, soldering, adhesives, and the like. However, preferably, the lands 34 at the electric contact surfaces 36 are merely pressed against the anode 14. In another aspect of the present invention, a carbon or graphite sheet (not shown) can be interposed between the lands 34 of the bipolar plates 10 and the electrode 14.

The introduced fuel produces an electrochemical reaction that causes hydrogen gas H₂ contained in the fuel to breakdown into positively-charged H⁺ ions and negatively-charged electrons. The negatively-charged electrons, i.e., electrical charge or current, are attracted to the positively-charged cathode 16 of the same membrane-electrode assembly 12a or 12b via an electrical circuit 31. The hydrogen ions H⁺ pass through a solid polymerized electrolyte membrane 18 to the cathode 16 of the same membrane-electrode assembly 12a or 12b. As the first electrochemical reaction is taking place at the anode 14, a second electrochemical reaction is taking place at the cathode 16 of the same membrane-electrode assembly 12a or 12b, where an oxidant, e.g., oxygen gas O₂ or air, passes over a catalytic material in the presence of the hydrogen ions H+. Preferably, the oxidant is similarly introduced through a plurality of plate channels 32 of the bipolar plate 10. The lands 34 of the bipolar plate 10 communicate and provide an electrical contact with the cathode 16 of the membrane-electron assembly 12a or 12b at a second contact surface 38. The nature of the communication/electrical contact surfaces 38 can include welding, soldering, adhesives, and the like. However, preferably, the lands 34 at the electric contact surfaces 38 are merely pressed against the cathode 16. In another aspect of the present invention, a carbon or graphite sheet (not shown) can be interposed between the lands 34 of the bipolar plates 10 and the electrode 16.

This second electrochemical reaction produces a water H₂O bi-product. Preferably, the plate channels 32 and the bipolar plate 10 are structured and arranged to transport the water H₂O to a desirable location.

The electrons collected at the cathode 16 of one membrane-electrode assembly 12a are communicated to the anode 14 of an adjacent membrane-electrode assembly 12b via a bipolar plate 10. Thus, the plurality of membrane-electrode assemblies 12a and 12b is connected electrically in series, hence, the flow of electrons is cumulative as the electrons are passed from one membrane-electrode assembly 12a to another 12b.

Niobium-clad bipolar plate 10, preferably, can be structured and arranged in manufacture to provide a plurality of lands 34 and a plurality of plate channels 32, the purposes for which have already been described. Preferably, the bipolar plate 10 is structured and arranged to be about five (5) to about 20 mils thick. Thinner bipolar plates 10 reduce weight and save space. Preferably, the bipolar plates 10 comprise protective layers 31 and 33, e.g., a niobium cladding layer, on opposing surfaces, i.e., the upper surface 31 and the lower surface 33, of the base metal substrate 37. In one embodiment, each of the protective layers 31 and 33 is about 0.1 to about three (3) mils thick. More preferably, each of the protective layers 31 and 33 is about one (1) mil thick.

When, alternatively, a niobium-clad bipolar plate 10 includes an interlayer, the bipolar plate can be structured and arranged to be about five (5) mils to about 0.10 inches thick. Preferably, the bipolar plates 10 comprise outer protective layers 31 and 33 that are clad on a thin barrier layer, e.g., titanium (Ti)on opposing surfaces of the base metal substrate 37. In one embodiment, each of the protective layers 31 and 33 is about 0.1 to about three (3) mils thick and the interlayer is about one (1) to about five (5) mils thick. More preferably, each of the protective layers 31 and 33 and the interlayer are about one (1) mil thick.

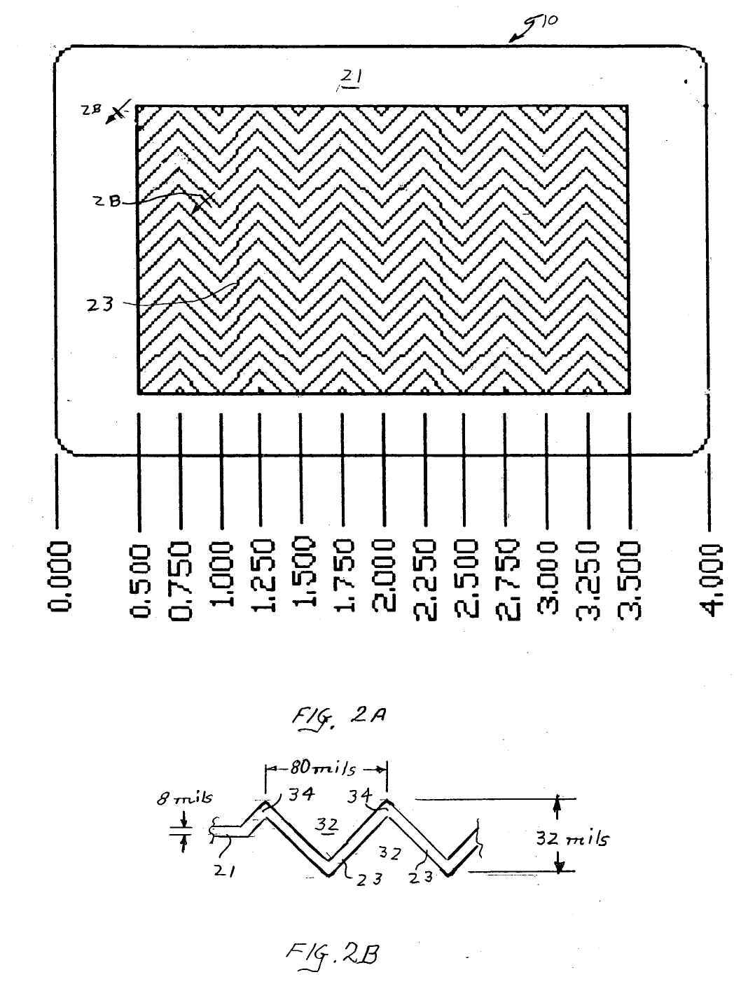

Referring now to FIG. 2A, there is shown an illustrative embodiment of a bipolar plate 10 in accordance with the present invention. The bipolar plate 10 has a substantially rectangular shape with a length and width of about 4 inches and 2.5 inches, respectively. Preferably, the bipolar plate 10 has been structured and arranged to include a substantially planar, outer region 21 and a ridged, or corrugated, inner region 23. In the specific embodiment, the outer region 21 can varying in width between about 0.375 inches and 0.5 inches. Furthermore, a plurality of securing holes (not shown), e.g., for bolts, screws, and the like, can be configured and arranged in the outer region 21, e.g., in the four corners, for the purpose of removably securing the bipolar plate 10 to adjacent membrane-electrode assemblies.

In one embodiment, the inner region 23 is configured and arranged to provide a corrugated orientation with, e.g., a zigzag pattern for efficiency. A cross-sectional view of the exemplary bipolar plate 10 is shown in FIG. 2B. The substantially planar, outer region 21 is about 8 mils thick and the inner region 23 has been structured and arranged to provide a peak-to-peak distance between lands 34 of about 80 mils and an amplitude of about 32 mils. Those of ordinary skill in the art will recognize that the dimensions provided herein are illustrative only and the invention is not to be construed as being limited thereto.

In one embodiment of the exemplary niobium-clad bipolar plate 10 shown in FIGS. 2A and 2B, the inner region 21 and outer region 23 are manufactured from the same piece of clad metal material, e.g., by stamping or forging. Alternatively, the outer perimeter 21 can be modified or replaced with a polymer-like gasket or frame to accomplish sealing and manifolding. Preferably, such a polymer-like gasket can be selected from a group consisting of elastomers, natural and synthetic rubber, plastic, and the like.

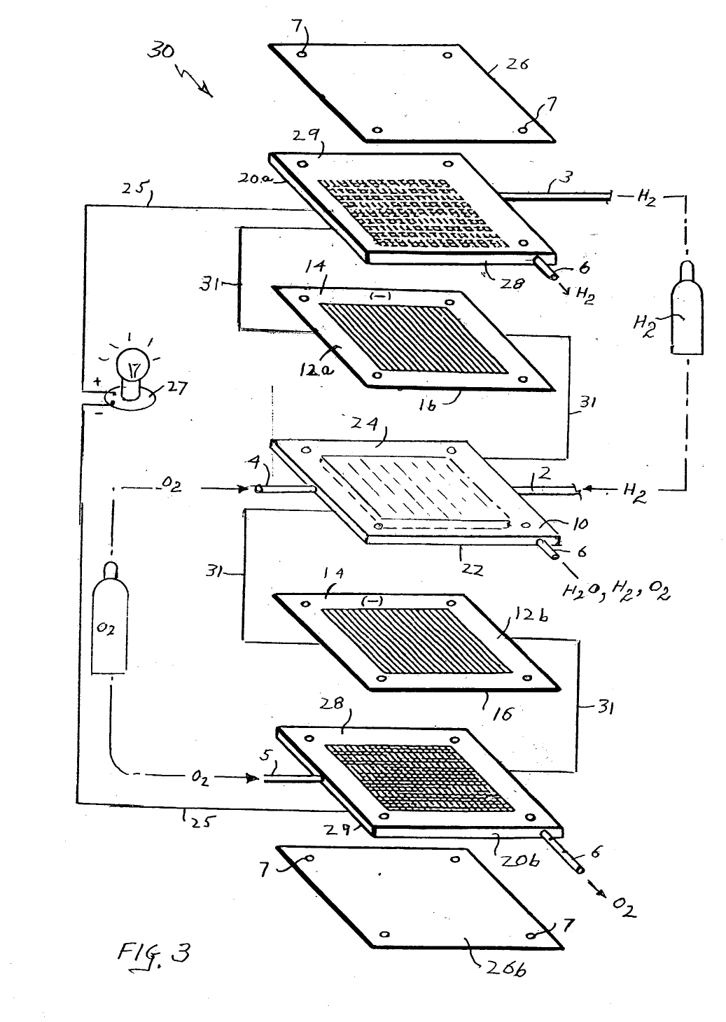

Referring now to FIG. 3, in a second embodiment, the present invention provides a system for producing electrical energy. The system comprises a bipolar plate 10, a pair of membrane-electrode assemblies 12a and 12b, which are shown in the figure with the anode 14 side towards the top of the page, a pair of current collectors 20a and 20b, and a pair of connector plates 26a and 26b.

The bipolar plate 10 is of a type described above, further comprising a fuel conduit 2 for the introduction of hydrogen gas H₂ and an oxidant conduit 4 for the introduction of an oxidant, e.g., air or oxygen gas O₂. The gases are introduced into the plate channels 32 on either side 22 and 24 of the bipolar plate 10. For the apparatus shown in FIG. 3, oxygen gas O₂ can be introduced into the plate channels 32 on the upper side 24 of the bipolar plate 10, so that oxygen gas O₂ travels through and along the plate channels 32 over and in proximity of the cathode 16 of the first membrane-electrode assembly 12a. Oxygen gas O₂ also can be introduced through an oxidant conduit 5 into the plate channels 32 of the inner face 28 of the lower current collector 20b, so that oxygen gas O₂ travels through the plate channels 32 over and in proximity of the cathode 16 of the second membrane-electrode assembly 12b. Similarly, for the apparatus shown in FIG. 3, hydrogen gas H₂ can be introduced into the plate channels 32 on the lower side 22 of the bipolar plate 10, so that hydrogen gas H₂ travels through the plate channels 32 over and in proximity of the anode 14 of the second membrane-electrode assembly 12b. Hydrogen gas H₂ also can be introduced in the plate channels 32 of the inner face 28 of the upper current collector 20a, so that hydrogen gas H₂ will travel through the plate channels 32 over and in proximity of the anode 14 of the first membrane-electrode assembly 12a. The electrochemical reactions have been described previously.

Preferably, the inner face 28 of the current collectors 20a and 20b is structured and arranged substantially identical to the upper or lower side 24 and 22 of the bipolar plate 10, which is to say that the inner face 28 comprises a thin cladding of niobium (Nb) or, alternatively, a first, innermost cladding layer of titanium (Ti) and a second, outermost cladding layer of niobium (Nb), and, furthermore, the inner face 28 is corrugated to provide pluralities of lands 34 and plate channels 32 through which gases can be introduced and water bi-product removed.

Preferably each of the current collectors 20a and 20b includes an electrical circuit 25, which can be connected to a load 27. More preferably, a series circuit 31 is provided to complete the electrical circuitry.

A plurality of holes 7 is shown illustratively on each of the component parts of the two-cell system 30 to connect or otherwise join the component parts. Connecting means, for example, can include bolts, screws, rivets, clamps, and the like.

Each of the current collectors 20a and 20b and the bipolar plate 10 includes an outlet conduit 6 through which fluids, e.g., water, hydrogen gas, or oxidant gas, can be removed. The current collectors 20a and 20b and the bipolar plate 10, furthermore, can be cooled by convection by circulating a fluid, e.g., air, water, oil, coolant, water ethyl glycol, and the like, through a conduit (not shown) provided therefor.

Referring again to FIG. 3, in a third embodiment, the present invention provides a proton exchange membrane fuel cell that includes one or more bipolar plates 10 of a type described above. PEM fuel cells are well known to the art and will not be described in detail here. The PEM fuel cell of the present invention comprises a plurality, and more preferably, a multiplicity of membrane-electrode assemblies 12a and 12b having bipolar plates 10 of the type described above that is structured and arranged in series. The plurality of membrane-electrode assemblies 12a and 12b and joining bipolar plates 10 are of a type that has been described previously with the cathode 16 of one membrane-electrode assembly 12a connected to the anode 14 of an adjacent membrane-electrode assembly 12b via a niobium-clad bipolar plate 10. More preferably, the bipolar plates 10 are niobium-clad base metal sheets that have been structured and arranged to provide a plurality of lands 34 and plate channels 34 as and for the reasons previously described. Alternatively, the bipolar plates 10 are niobium (Nb) and titanium (Ti) clad base metal sheets, as described above

The PEM fuel cell of the present invention 30 further comprises an inlet or port for the fuel, e.g., hydrogen gas H₂, natural gas, ethanol, and the like, and an inlet or port for the oxidant, e.g., oxygen gas O₂ or air. Preferably, fuel, e.g., hydrogen gas H₂, can be introduced through a conduit 2 into the plate channels 32 between the lands 34 of the lower side 22 of the bipolar plate 10 and through a conduit 3 on the inner face 28 of a current collector 20a as previously described. Moreover, oxygen gas O₂, for example, can be introduced through a conduit 4 into the plate channels 32 between the lands 34 of the upper side 24 of the bipolar plate 10 and through a conduit 5 on the inner face 28 of a current collector element 20b as described previously. A third conduit 6 can be provided in the bipolar plate 10 and the current collector 20a and 20b to remove and transport fluids, e.g., water H₂O bi-product and or the gases, to a desired location.

The PEM fuel cell 30 further comprises an electrical circuit 31 whereby useful electrical current, i.e., power, can flow between the various components or cells of the fuel cell 30. At one or more points in this electrical circuit 31, power can be provided to an external load 27 via external circuitry 25. External circuitry 25 and the internal electrical circuit 31 are of a type well known to the art and will not be described further.

Although a number of embodiments of the present invention have been described, it will become obvious to those of ordinary skill in the art that other embodiments to and/or modifications, combinations, and substitutions of the present invention are possible, all of which are within the scope and spirit of the disclosed invention.

For example, the preferred embodiment of a bipolar plate in accordance with the present invention is a single plate. However, those skilled in the art will recognize that multiple plates, i.e., niobium-clad base metal plates, can be structured and arranged with respect to one another in a back-to-back configuration so that the base metal portion of each of the two plates is in direct communication and contact with the other base metal portion so as to be mirror images of one another. The base metal plates can be secured to one another in any manner known to the art, e.g., adhesives, epoxy, soldering, welding, clamps, screws, bolts, and the like.

With such a configuration, one or more of the base metal portions can include a plurality of cooling holes through which a fluid, e.g., water, oil, water ethylglycol, and the like, can be circulated to remove heat from the base metal portions.

What I claim is:

1. An electrically-conductive, corrosion-resistant device for communicating electrical energy in an electrochemical apparatus, the device comprising a composite metal sheet, the composite metal sheet further comprising:
a base metal substrate, having an upper and a lower surface, wherein the base metal has a first electrical conductivity;
at least one top layer of a conductive, corrosion-resistant material that is metallurgically clad to the upper surface of the base metal substrate; and
at least one bottom layer of a conductive, corrosion-resistant material that is metallurgically clad to the lower surface of the base metal substrate, wherein the at least one bottom layer and the at least one top layer have a second electrical conductivity that is less than the first electrical conductivity.

2. The device as recited in claim 1, wherein the device is a bipolar plate that is in communication with a cathode from a first membrane-electrode assembly and an anode of a second, adjacent membrane-electrode assembly, wherein electrons from the cathode of the first membrane-electrode assembly can flow to the anode of the second membrane-electrode assembly via the bipolar plate.

3. The device as recited in claim 2, wherein the device is structured and arranged to provide a plurality of at least one of lands and peaks, wherein the plurality of at least one of lands and peaks provides an electrical junction between the an electrode of the first membrane-electrode assembly and the upper surface of the base metal substrate and between an electrode of opposite charge of the second membrane-electrode assembly and the lower surface of the base metal substrate.

4. The device as recited in claim 1, wherein the base metal comprises a metal selected from the group consisting of stainless steel, aluminum, aluminum alloys, titanium, titanium alloys, or copper alloys.

5. The device as recited in claim 1, wherein the electrochemical apparatus is a proton exchange membrane fuel cell.

6. The device as recited in claim 1, wherein the corrosion-resistant material is selected from a group comprising niobium, tantalum, titanium, ruthenium, rhodium, palladium, silver, iridium, platinum, gold, tungsten, tellurium, refractory group metals, and alloys thereof.

7. The device as recited in claim 1, wherein each of the at least one layer of a corrosion-resistant material comprises a layer of niobium that is clad to the base metal substrate.

8. The device as recited in claim 7, wherein the niobium layer clad to the base metal substrate is between about 0.1 and about three (3) mils thick.

9. The device as recited in claim 8, wherein the niobium layer clad to the base metal substrate is about one (1) mil thick.

10. The device as recited in claim 1, wherein each of the at least one layer of a corrosion-resistant material comprises a first layer of titanium that is in communication with and clad to the base metal substrate and a second layer of niobium that is in communication with and clad to the first layer of titanium.

11. The device as recited in claim 10, wherein the second layer of niobium is between about 0.1 and about one (1) mils thick and the first layer of titanium in communication with the base metal substrate is between about one (1) and about five (5) mils thick.

12. The device as recited in claim 1, wherein the device further includes a substantially planar outer region having a plurality of holes for use in mounting the device.

13. The device as recited in claim 12, where in the substantially planar outer region is fabricated to accomplish sealing and manifolding from a sealing material selected from the group consisting of elastomers, natural and synthetic rubber or plastic.

14. A device for communicating electricity between an electrode of a first membrane-electrode assembly and an electrode of opposite charge of a second membrane-electrode assembly, wherein the device comprises a composite metal sheet further comprising an electric conductivity base metal substrate, having at least one top layer of an electrically-conductive, corrosion-resistant material clad to an upper surface of the base metal substrate and at least one bottom layer of an electrically-conductive, corrosion-resistant material clad to a lower surface of the base metal substrate, wherein the at least one top layer of a corrosion-resistant material clad to the upper surface of the base metal substrate is in electrical communication with the electrode of the first membrane-electrode assembly and the at least one bottom layer of a corrosion-resistant material clad to the lower surface of the base metal substrate is in electrical communication with the electrode of the second membrane-electrode assembly.

15. The device as recited in claim 14, wherein the composite metal sheet is corrugated to provide a plurality of at least one of lands and peaks, wherein the plurality of at least one of lands and peaks provides an electrical junction between the electrode of the first membrane-electrode assembly and the upper surface of the base metal substrate and between the electrode of opposite charge of the second membrane-electrode assembly and the lower surface of the base metal substrate.

16. The device as recited in claim 14, wherein the base metal substrate is fabricated from a metal selected from the group consisting of stainless steel, aluminum, aluminum alloys, titanium, titanium alloys or copper alloys.

17. The device as recited in claim 14, wherein the corrosion-resistant material comprises a material selected from the group consisting of niobium, tantalum, titanium, ruthenium, rhodium, palladium, silver, iridium, platinum, gold, tungsten, tellurium, refractory group metals, or alloys thereof.

18. The device as recited in claim 14, wherein the each of the at least one layer of a corrosion-resistant material comprises a first layer of titanium that is in communication with and clad to the base metal substrate and a second layer of niobium that is in communication with and clad to the first layer of titanium.

19. A system for producing electricity using a fuel and an oxidant, wherein the system comprises:
a plurality of membrane-electrode assemblies, wherein each of the plurality of membrane-electrode assemblies comprises:
a negatively charged electrode against which the fuel is introduced with a first catalyst to provide electricity and a plurality of hydrogen ions,
a positively charged electrode against which the oxidant is introduced with a second catalyst in the presence of the plurality of hydrogen ions to provide water, and
a membrane that is interposed between the negatively charged electrode and the positively charged electrode for the transport of the plurality of hydrogen ions from said negatively charges electrode to said positively charged electrode;
a device for communicating electricity between an electrode of a first membrane-electrode assembly and an electrode of opposite charge of a second membrane-electrode assembly, wherein the device comprises a composite metal sheet further comprising:
a base metal substrate, having an upper and a lower surface, wherein the base metal has a first electrical conductivity, at least one top layer of an electrically-conductive, corrosion-resistant material that is metallurgically clad to the upper surface of the base metal substrate, and
at least one bottom layer of an electrically-conductive, corrosion-resistant material that is metallurgically clad to the lower surface of the base metal substrate,
wherein the at least one bottom layer and the at least one top layer have a second electrical conductivity that is less than the first electrical conductivity;
a first current collector, wherein the first current collector is in electrical communication with a positively charged electrode of one of the plurality of membrane-electrode assemblies, which electrode is not in communication with the device for communicating electricity between an electrode of a first membrane-electrode assembly and an electrode of opposite charge of a second membrane-electrode assembly; and
a second current collector, wherein the second current collector is in electrical communication with a negatively charged electrode of another of the plurality of membrane-electrode assemblies, which electrode is not in communication with the device for communicating electricity between an electrode of a first membrane-electrode assembly and an electrode of opposite charge of a second membrane-electrode assembly.

20. The system as recited in claim 19, wherein the composite metal sheet of the device is corrugated to provide a plurality of at least one of lands and peaks and a plurality of at least one of channels and troughs on an upper and a lower side of the device, wherein the plurality of at least one of lands and peaks on the upper side of the device provides an electrical junction between the electrode of the first membrane-electrode assembly and the upper surface of the base metal substrate and the plurality of at least one of lands and peaks on the lower side of the device provides an electrical junction between the electrode of opposite charge of the second membrane-electrode assembly and the lower surface of the base metal substrate.

21. The system as recited in claim 19, wherein the base metal substrate is fabricated from a base metal selected from the group consisting of stainless steel, aluminum, aluminum alloys, titanium, titanium alloys or copper alloys.

22. The system as recited in claim 19, wherein the corrosion-resistant material is selected from the group consisting of niobium, tantalum, titanium, ruthenium, rhodium, palladium, silver, iridium, platinum, gold, tungsten, tellurium, refractory group metals or alloys thereof.

23. The system as recited in claim 19, wherein each of the at least one layer of a corrosion-resistant material comprises a layer of niobium that is metallurgically clad to the base metal substrate.

24. The system as recited in claim 19, wherein one or more of the at least one layer of a corrosion-resistant material comprises a first layer of titanium that is metallurigically clad to the base metal substrate and a second layer of niobium that is metallurgically clad to the first layer of titanium.

25. The system as recited in claim 20, wherein the fuel can be introduced to the second membrane-electrode assembly in the presence of a catalyst through the plurality of at leas one of channels and troughs on the lower side of the device.

26. The system as recited in claim 20, wherein the oxidant gas can be introduced to the first membrane-electrode assembly in the presence of a catalyst and hydrogen protons through the plurality of at least one of channels and troughs on the upper side of the device.

27. The system as recited in claim 20, wherein water can be transported through the plurality of at least one of channels and troughs on the lower side of the device.

28. The system as recited in claim 19, wherein the system further comprises a pair of connector plates.

29. The system as recited in claim 19, wherein the system further comprises a pair of current collectors for collecting the current produced by the system and for delivering said current to a load.

30. The system as recited in claim 19, wherein the device for communicating electricity, the first end plate, and the second end plate each include one or more fluid conduits for transporting at least one of fuel, oxidant, and water.

31. A proton exchange membrane fuel cell, the fuel cell comprising:
an inlet for providing a fuel to a first electrode;
an inlet for providing an oxidant to a second electrode;
a plurality of membrane-electrode assemblies, wherein each of the plurality of membrane-electrode assemblies comprises:
a negatively charged electrode against which the fuel is introduced with a first catalyst to provide electricity and a plurality of hydrogen ions,
a positively charged electrode against which the oxidant is introduced with a second catalyst in the presence of the plurality of hydrogen ions to provide water, and
a membrane that is interposed between the negatively charged electrode and the positively charged electrode for the transport of the plurality of hydrogen ions from said negatively charges electrode to said positively charged electrode;
a device for communicating electricity between an electrode of a first membrane-electrode assembly and an electrode of opposite charge of a second membrane-electrode assembly, wherein the device comprises a composite metal sheet further comprising an electrically conductivity base metal substrate having at least one top layer of an electrically-conductive, corrosion-resistant material metallurgically clad to an upper surface of the base metal substrate and at least one bottom layer of an electrically-conductive, corrosion-resistant material metallurgically clad to a lower surface of the base metal substrate, wherein the at least one top layer of a corrosion-resistant material clad to the upper surface of the base metal substrate is in electrical communication with the electrode of the first membrane-electrode assembly and the at least one bottom layer of a corrosion-resistant material clad to the lower surface of the base metal substrate is in electrical communication with the electrode of the second membrane-electrode assembly;
one or more first current collectors, wherein each of the one or more first current collectors is in electrical communication with a positively charged electrode of one of the plurality of membrane-electrode assemblies, which electrode is not in communication with the device for communicating electricity between an electrode of a first membrane-electrode assembly and an electrode of opposite charge of a second membrane-electrode assembly;
one or more second current collectors, wherein each of one or more second current collectors is electrical communication with a negatively charged electrode of another of the plurality of membrane-electrode assemblies, which electrode is not in communication with the device for communicating electricity between an electrode of a first membrane-electrode assembly and an electrode of opposite charge of a second membrane-electrode assembly; and
electrical circuitry for communicating electricity produced by the proton exchange membrane fuel cell to an external load.

32. The fuel cell as recited in claim 31, wherein the composite metal sheet of the device is corrugated to provide a plurality of at least one of lands and peaks and a plurality of at least one of channels and troughs, wherein the plurality of at least one of lands and peaks provides an electrical junction between the electrode of the first membrane-electrode assembly and the upper surface of the base metal substrate and between the electrode of opposite charge of the second membrane-electrode assembly and the lower surface of the base metal substrate.

33. The fuel cell as recited in claim 31, wherein the inlet for providing the fuel to the first electrode introduces a fluid containing hydrogen gas to the second membrane-electrode assembly in the presence of a catalyst through a plurality of at least one of channels and troughs on the lower side of the device.

34. The fuel cell as recited in claim 31, wherein the inlet for providing the oxidant to the second electrode introduces a fluid containing oxygen gas to the first membrane-electrode assembly in the presence of a catalyst and hydrogen protons through a plurality of at least one of channels and troughs on the upper side of the device.
